(19) United States
(12) Patent Application Publication
(10) Pub. No.: US 2026/0362303 A1
(43) Pub. Date: Nov. 12, 2026

(54) TECHNOLOGIES TO IDENTIFY SATELLITE CELL IN WIRELESS CELLULAR NETWORK

(71) Applicant: Apple Inc., Cupertino, CA (US)

(72) Inventors: Roland Gruber, Sauerlach (DE); Robert Zaus, Munich (DE)

(73) Assignee: Apple Inc., Cupertino, CA (US)

(21) Appl. No.: 19/201,847

(22) Filed: May 7, 2025

(51) Int. Cl. H04W 48/18; H04W 60/00; H04W 84/04

(52) U.S. Cl. CPC H04W 48/18; H04W 60/00; H04W 84/042

(57) ABSTRACT

The present application relates to technologies for identifying a satellite cell (e.g., non-terrestrial network (NTN) cell or another satellite-based cell) in a wireless cellular network. In an example, one or more public land mobile network (PLMN) identities (IDs), tracking areas (e.g., tracking area identities (TAIs)), and/or carrier frequencies (e.g., absolute radio frequency channel numbers (ARFCNs)) may be designated for satellite cells. The network may transmit a non-access stratum (NAS) message, such as a mobility management message, that includes an information element (IE) to indicate the one or more PLMN IDs, TAIs, and/or carrier frequencies designated for satellite cells. Embodiments further provide schemes for prioritizing and/or deprioritizing a satellite cell during PLMN and/or cell selection (or reselection).

### TECHNICAL FIELD

This application relates generally to communication networks and, in particular, to technologies to identify a satellite cell in a wireless cellular network.

### BACKGROUND

In Third Generation Partnership (3GPP) cellular networks, non-terrestrial networks (NTNs) have been developed to service more areas, including remote areas. NTNs may deploy satellites to provide network service to user equipments (UEs). Some protocols and procedures may be adapted for use with NTNs. For example, because of the longer transmission distances and higher transmission error rates compared to a terrestrial network, certain timer values or the maximum number of certain retransmissions may be increased for a satellite cell.

### BRIEF DESCRIPTION OF THE DRAWINGS

FIG. 1 illustrates an example of a network environment in accordance with some embodiments.

FIG. 2 illustrates an example information element (IE) to indicate one or more public land mobile network (PLMN) identities (IDs) designated for satellite cells, in accordance with some embodiments.

FIG. 3 illustrates an example IE to indicate one or more tracking area identities (TAIs) designated for satellite cells, in accordance with some embodiments.

FIG. 4 illustrates an example TAI list with non-consecutive TAIs of the same PLMN, in accordance with some embodiments.

FIG. 5 illustrates an example TAI list with consecutive TAIs of the same PLMN, in accordance with some embodiments.

FIG. 6 illustrates an example TAI list with TAIs of different PLMNs, in accordance with some embodiments.

FIG. 7 illustrates an example IE to indicate one or more carrier frequencies (e.g., absolute radio frequency channel numbers (ARFCNs)), in accordance with some embodiments.

FIG. 8 illustrates an example ARFCN list with non-consecutive ARFCNs of the same PLMN, in accordance with some embodiments.

FIG. 9 illustrates an example ARFCN list with consecutive ARFCNs of the same PLMN, in accordance with some embodiments.

FIG. 10 illustrates an example ARFCN list with ARFCNs of different PLMNs, in accordance with some embodiments.

FIG. 11 illustrates an example attach procedure in accordance with some embodiments.

FIG. 12 illustrates an example tracking area update procedure in accordance with some embodiments.

FIG. 13 illustrates an example globally unique temporary identifier (GUTI) reallocation procedure in accordance with some embodiments.

FIG. 14 illustrates an example UE-initiated detach procedure in accordance with some embodiments.

FIG. 15 illustrates an example network-initiated detach procedure in accordance with some embodiments.

FIG. 16 illustrates an example registration procedure in accordance with some embodiments.

FIG. 17 illustrates an example configuration update procedure in accordance with some embodiments.

FIG. 18 illustrates an example UE-initiated deregistration procedure in accordance with some embodiments.

FIG. 19 illustrates an example network-initiated deregistration procedure in accordance with some embodiments.

FIG. 20 illustrates an example of an operational flow/algorithmic structure in accordance with some embodiments.

FIG. 21 illustrates another example of an operational flow/algorithmic structure in accordance with some embodiments.

FIG. 22 illustrates another example of an operational flow/algorithmic structure in accordance with some embodiments.

FIG. 23 illustrates an example of a UE in accordance with some embodiments.

FIG. 24 illustrates an example of a network device in accordance with some embodiments.

### DETAILED DESCRIPTION

Embodiments of the present disclosure relate to, among other things, technologies for identifying a satellite cell (e.g., non-terrestrial network (NTN) cell) in a wireless cellular network. In an example, one or more public land mobile network (PLMN) identities (IDs), tracking areas (e.g., tracking area identities (TAIs)), and/or carrier frequencies (e.g., absolute radio frequency channel numbers (ARFCNs)) may be designated for satellite cells. The network (e.g., a mobility management entity (MME) or an access and mobility management function (AMF)) may transmit a non-access stratum (NAS) message, such as a mobility management message, that includes an information element (IE) to indicate the one or more PLMN IDs, TAIs, and/or carrier frequencies designated for satellite cells. Embodiments further provide schemes for prioritizing and/or deprioritizing a satellite cell during PLMN and/or cell selection (or reselection).

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” “or “processing circuitry” as used herein refers to, is part of, or includes circuitry capable of carrying out a set of arithmetic or logical operations, and/or recording, storing, and/or transferring digital data. The term “processor circuitry” and “processing circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, device, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface. The UE can communicate with another UE or a network and the UE may be integrated with other devices and/or systems (e.g., in a vehicle).

The term “base station” as used herein refers to a device with radio communication capabilities, that is a device of a communications network (or, more briefly, network), and that may be configured as an access node in the communications network. The logical functionality and/or physical deployment of the base station may be distributed among various units (e.g., Central Unit (CU), Distributed Unit (DU), Remote Unit (RU), etc.) within a radio access network (RAN). A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, repeater on a communications satellite, etc.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

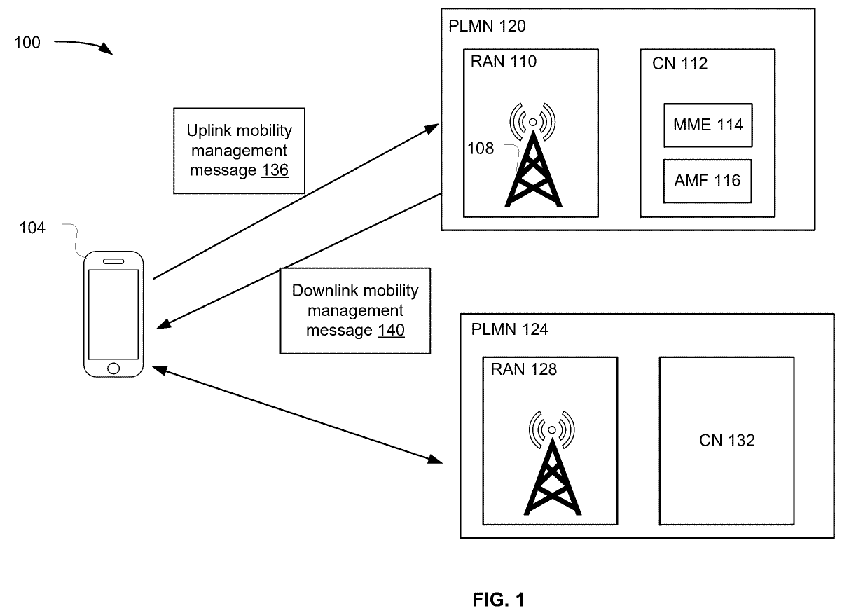

FIG. 1 illustrates a network environment 100, in accordance with some embodiments. The network environment 100 may include a UE 104 communicatively coupled with a base station 108 of a radio access network (RAN) 110. The base station 108 provides a wireless access cell, for example, a Third-Generation Partnership Project (3GPP) New Radio (NR) cell, through which the UE 104 may communicate with the gNB. The base station 108 may include a set of transmission and reception points (TRPs). The UE 104 and the base station 108 may communicate over an interface compatible with 3GPP technical specifications, such as those that define Fourth-Generation (4G) (e.g., Long Term Evolution (LTE)) standards, Fifth-Generation (5G) NR system standards, Sixth-Generation (6G) standards, or the like.

The network environment 100 may further include a core network (CN) 112. For example, the CN 112 may comprise a 4G core network (4GC), 5G core network (5GC), 6G core network (6GC), or later generation core network. The CN 112 may be coupled to the base station 108 via a fiber optic or wireless backhaul. The CN 112 may provide functions for the UE 104 via the base station 108. These functions may include managing subscriber profile information, subscriber location, authentication of services, or switching functions for voice and data sessions. In some embodiments, the CN 112 may include a mobility and management entity (MME) 114 and/or an access and mobility management function (AMF) 116.

As used herein, operations described with respect to a “network” may be performed by one or more components of the RAN 110 (e.g., base station 108) or the CN 112 (e.g., MME 114 and/or AMF 116). Additionally, as used herein, the UE 104, base station 108, MME 114, and/or AMF 116 can reference to the entire device or any logical or physical components of the device (e.g., transmitter, receiver, modem, application processor, processing circuitry, etc.).

The RAN 110 and/or CN 112 may be associated with a first PLMN 120. Multiple cells and/or base stations may be associated with the first PLMN. The network environment 100 may include multiple PLMNs. For example, as shown in FIG. 1, the network environment 100 may include a second PLMN 124, which may include a RAN 128 and/or a CN 132. In an example, different PLMNs may be provided by different network operators. In another example, the same network operator may provide PLMNs with different PLMN IDs as further described herein. In this case, the PLMNs may share one or more components, such as one or more base stations (e.g., base station 108) and/or one or more components of the core network (e.g., MME 114 and/or AMF 116).

One or more of the PLMNs 120 or 124 and/or associated cells may employ satellite access technology to implement a satellite access-based PLMN and/or satellite cell. The PLMNs and/or cells of the network environment 100 may further include one or more terrestrial PLMNs and/or cells.

The UE 104 may perform a network selection procedure to select one of the available PLMNs. This procedure may be performed when the UE 104 powers on, recovers from a loss of coverage, or performs a periodic re-evaluation. For example, in fourth-generation (4G) networks, e.g., long term evolution (LTE) networks, the UE 104 may perform various evolved packet system (EPS) mobility management procedures specified by 3GPP Technical Specification (TS) 24.301, V 18.9.0 (2025-01), such as an attach procedure, tracking area update procedure, and/or detach procedure, among others. As part of the EPS mobility management procedures, the UE may transmit one or more mobility management messages to an MME of the network (e.g., MME 114) and/or receive one or more mobility management messages from the MME via NAS signaling.

For 5G networks, e.g., NR networks, the UE 104 may perform various 5G system (5GS) mobility management procedures, e.g., as specified by 3GPP TS 24.501, V18.10.0 (2025-03), such as a registration procedure (e.g., initial registration procedure or mobility registration update procedure), configuration update procedure, and/or deregistration procedure, among others. As part of the 5GS mobility management procedures, the UE may transmit one or more mobility management messages to an AMF (e.g., AMF 116) of the network and/or receive one or more mobility management messages from the AMF via NAS signaling.

For example, FIG. 1 illustrates an uplink mobility management message 136 transmitted by the UE 104 to the PLMN 120 (e.g., MME 114 and/or AMF 116) and a downlink mobility management message 140 received by the UE 104 from the PLMN 120 (e.g., MME 114 and/or AMF 116). In embodiments herein, the downlink mobility management message 140 transmitted by the PLMN to the UE 104 may include an IE to indicate one or more PLMN IDs, tracking areas (e.g., TAIs), and/or carrier frequencies (e.g., ARFCNs) designated for satellite access technology (e.g., satellite cells).

In existing technologies, a UE may select and attempt to register on a PLMN according to a prioritized order of selection defined within automatic network selection procedures of 3GPP Technical Specification (TS) 23.122 v18.10.0 (2025-03). The PLMNs of the highest priority include a home PLMN (HPLMN) or an equivalent home HPLMN (EHPLMN). The PLMNs of the second highest priority are those listed in a “user-controlled PLMN selector with access technology” data file in a subscriber identity module (SIM) in priority order. The PLMNs of the third highest priority are those listed in an “operator-controlled PLMN selector with access technology” data file in the SIM or stored in the memory of the UE in priority order. The PLMNs of the fourth highest priority are other PLMNs with a received high-quality signal in random order. The PLMNs of the fifth highest priority are other PLMNs in order of decreasing signal quality. Additional priority levels are provided for forbidden PLMNs that operate with respect to disaster conditions. In the event that a PLMN of the first three priority levels is present, the signal level of available cells is not taken into account and selection is based solely on the cell-selection criteria broadcast by a PLMN and a priority of networks.

As discussed above, multiple cells may be associated with a given PLMN. The UE 104 may perform a cell selection and/or reselection procedure to select a cell associated with the serving PLMN.

Some adaptations of NAS protocols for support of satellite-based cells are under discussion for adoption in 3GPP standards, such as TS 24.301 and/or TS 24.501. The adaptations may be applicable for a UE that camps on a satellite cell. Example adaptations for satellite-based cells may include support of multiple tracking area codes per cell, mobility management cause code “PLMN not allowed to operate at the present UE location” (e.g., cause code #78), roaming restrictions for satellite access, satellite access as a separate access technology for PLMN selection, and/or NAS timer adaptations. For example, because of the longer transmission distances and higher transmission error rates compared to a terrestrial network, certain timer values or the maximum number of certain retransmissions may be increased for a satellite cell. Therefore, a UE may need to be able to determine whether it is operating in a satellite cell. Some real-world deployments of wireless cellular networks with satellite access are not supporting certain adaptations specified by 3GPP for NTN cells. Specifically, the deployments may not support the enhancements to the system information broadcast which could be used by a UE to unambiguously identify a cell as a satellite cell. Therefore, other means are needed by which the UE can determine whether a cell is a satellite cell.

However, it has not been defined how the UE determines that a cell is a satellite cell. One possibility is for the UE to detect a satellite cell based on contents of the system information broadcast (SIB) of the cell, e.g., whether the SIB includes the “cellBarred-NTN” information element. However, in some deployments, such as direct-to-cell (D2C) satellite deployments, the network operator may not include NTN extensions in access stratum (AS) signaling. This may enable legacy UEs to camp on and/or connect with a satellite cell. The satellite cell may be an NTN cell or another satellite-based cell that does not incorporate NTN extensions.

Various embodiments herein provide techniques for a UE to identify whether a cell is a satellite cell via NAS signaling. In an example, one or more PLMN IDs, TAIs (e.g., within a PLMN ID), and/or carrier frequencies (e.g., ARFCNs) may be designated for satellite cells. The network may include an IE that indicates the one or more PLMN IDs, TAIs, and/or carrier frequencies designated for satellite cells in one or more mobility management messages. Embodiments further provide schemes for prioritizing and/or deprioritizing a satellite cell during PLMN and/or cell selection (or reselection).

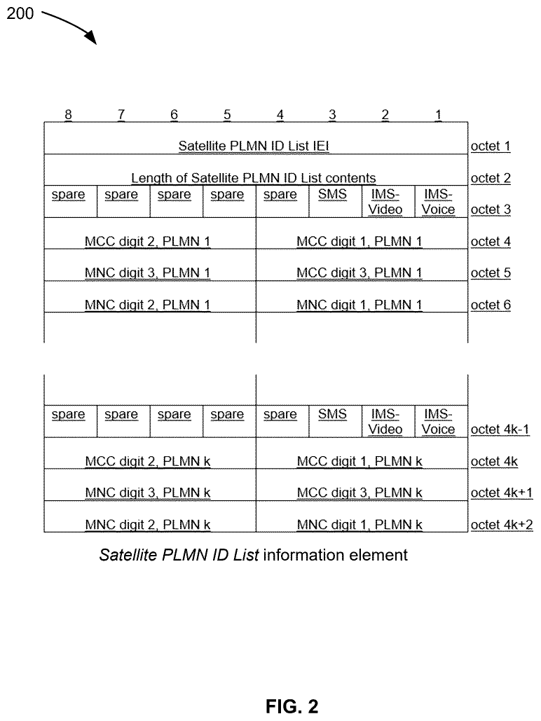

FIG. 2 illustrates an example IE 200 to indicate one or more PLMN IDs designated for satellite cells, in accordance with some embodiments. In an example, the IE 200 may be referred to as a “satellite PLMN ID list” IE. The network may transmit the IE 200 to a UE via dedicated NAS signaling. For example, the network may transmit the IE 200 in one or more mobility management messages, as further described herein. The IE 200 may be transmitted after security is enabled between the UE and the network, e.g., to ensure that the information is provided by a genuine PLMN.

In an example, the IE 200 may indicate PLMN IDs that are used for satellite-based PLMN deployments in a country (e.g., associated with a mobile country code (MCC)) and/or for a mobile network operator (e.g., associated with a mobile network code (MNC)). An individual PLMN ID may correspond to a combination of an MCC and an MNC. In some embodiments, the IE 200 may indicate one or more MCCs and/or MNCs for which the list of PLMN IDs is applicable. In an example, the IE 200 may indicate a pair of MCC and MNC for respective individual PLMN IDs. In some embodiments, the same network operator may be associated with more than one MNC, e.g., a first MNC dedicated for one or more satellite cells and a second MNC dedicated for one or more terrestrial cells (which may not be indicated in the IE 200).

The UE may store the information provided by the IE 200 (e.g., the list of PLMN IDs, such as associated MCC(s), and/or associated MNC(s)) in memory, such as non-volatile memory. The UE may detect the PLMN ID broadcasted by a cell (e.g., in a master information block (MIB) and/or SIB). If the PLMN ID broadcasted by the cell corresponds to one of the PLMN IDs indicated by the IE 200 (e.g., as stored in memory of the UE), the UE considers the cell to be a satellite cell (e.g., a satellite evolved universal terrestrial radio access (E-UTRAN) cell or a satellite next generation (NG)-RAN cell). Accordingly, the UE may consider the cell as deployed in satellite access technology as defined in 3GPP TS 23.122. This may enable capable UEs to utilize NTN-specific features.

In some embodiments, the IE 200 may further indicate one or more services supported by cells that broadcast a PLMN ID of the indicated list of PLMN IDs. For example, the IE 200 may include 1-bit flags to indicate whether respective services are supported. Example services may include voice service, video service, short message service (SMS), public internet service, etc. For example, IE 200 is illustrated in FIG. 2 to include flags for Internet protocol (IP) multimedia subsystem (IMS)-voice (e.g., indicated by octet 3, bit 1 of IE 200), IMS-video (e.g., indicated by octet 3, bit 2), and SMS (e.g., indicated by octet 3, bit 3). In an example, a value of 0 indicates that the service is not supported and a value of 1 indicates that the service is supported. In an example, the IE 200 may be a type 4 IE. It will be apparent that other services and/or coding schemes may be used in accordance with embodiments herein. For example, in some embodiments, a single flag may indicate whether multiple services are supported.

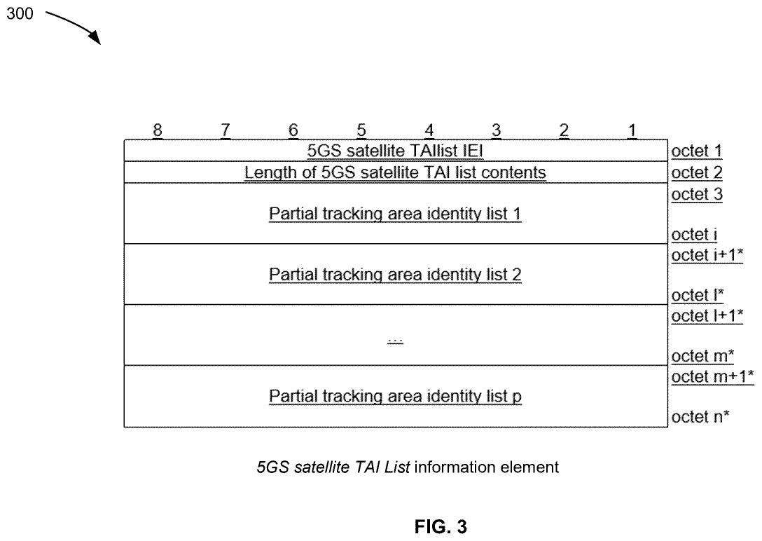

FIG. 3 illustrates an example IE 300 to indicate one or more TAIs (also referred to as tracking area codes (TACs)) designated for satellite cells, in accordance with some embodiments. In an example, the IE 300 may be referred to as a “satellite TAI list” IE.

The IE 300 may indicate one or more lists of TAIs, belonging to one or more PLMN IDs, that are reserved for satellite cells. The one or more TAIs may be a subset of TAIs associated with a given PLMN ID. Accordingly, non-satellite cells of the PLMN may use another TAI. The list of TAIs may include non-consecutive and/or consecutive TAI values. For example, the IE 300 may indicate individual (e.g., non-consecutive) TAIs in respective fields. In another example, the IE 300 may indicate a range of consecutive TAI values, e.g., by including a starting TAI value and a number of TAIs in the range (or an ending TAI value). In some embodiments, the IE 300 may include multiple TAI lists, e.g., referred to as partial TAI lists.

The TAI lists may include a type of list field to indicate a type of list. The type of list may indicate the contents and/or format of the TAI list. For example, the type of list may indicate that the TAI list includes non-consecutive TAI values, consecutive TAI values, or both. Additionally, or alternatively, the type of list may indicate whether the TAI list includes TAIs belonging to one PLMN or different PLMNs. As discussed above, the IE 300 may include multiple TAI lists (e.g., “partial TAI lists”). The type of the partial TAI lists may be the same or different.

The TAI lists may further include a number of elements field that indicates a number of TAIs in the TAI list. In an example, the type of list field and the number of elements field may be included in the first octet (octet 1) of the TAI list. The number of elements may be any integer from 1 to a maximum number (e.g., 16).

The UE may store the one or more TAI lists in memory (e.g., non-volatile memory). In an example, the IE 300 may be a type 4 IE. In some embodiments, the IE 300 may be limited to a maximum number (e.g., 16) of TAIs. If the IE 300 includes more than the maximum number of TAIs, the UE may store the first number of TAIs equal to the maximum number and ignore the remaining TAIs and/or octets of the IE 300.

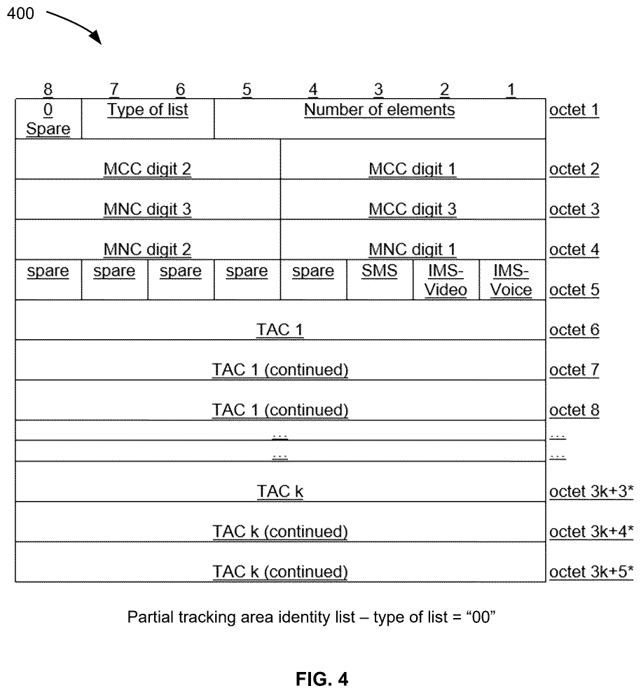

FIG. 4 illustrates an example of a TAI list 400 of a first type (e.g., type of list “00”) with individually indicated TAIs (e.g., non-consecutive TAIs) that belong to the same PLMN, in accordance with some embodiments. In an example, as shown in FIG. 4, for type of list=“00” and number of elements=k, octets 2 to 4 contain the MCC+MNC, and for j=1, . . . , k: octets 3j+3 to 3j+5 contain the TAC of the j-th TAI belonging to the partial list.

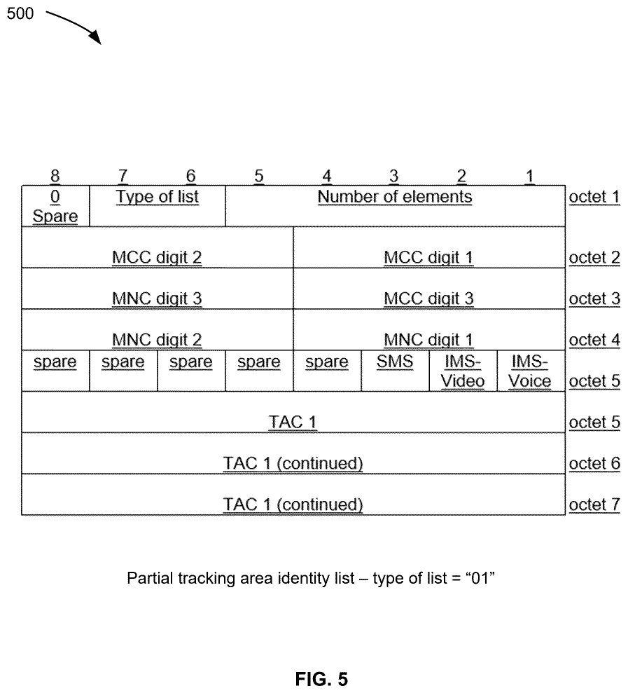

FIG. 5 illustrates an example of a TAI list 500 with a second type (e.g., type of list “01”) with consecutive TAIs that belong to a same PLMN, in accordance with some embodiments. In an example, as shown in FIG. 5, for type of list=“01” and number of elements=k: octets 2 to 4 contain the MCC+MNC, and octets 5 to 7 contain the TAC of the first TAI belonging to the partial list. The TAC values of the other k−1 TAIs are TAC+1, TAC+2, . . . , TAC+k−1.

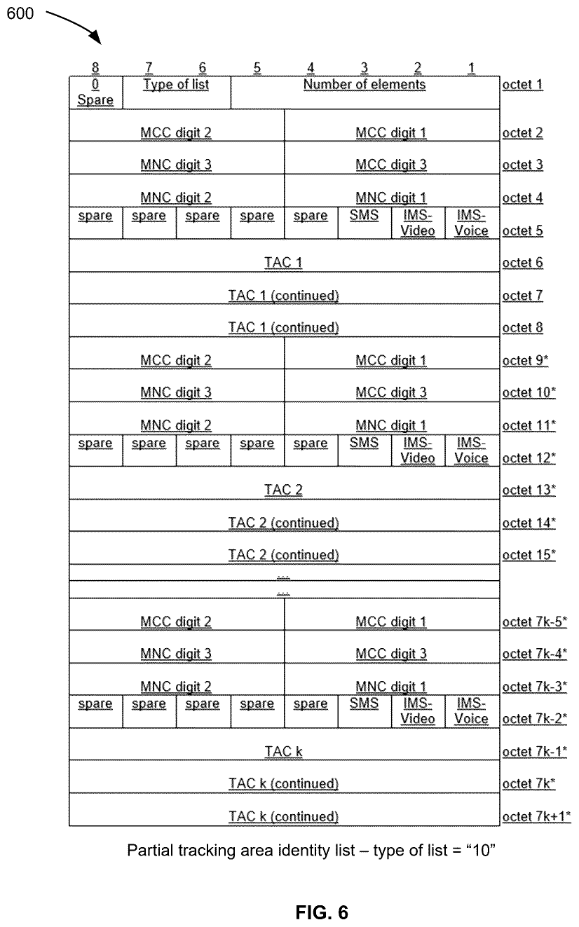

FIG. 6 illustrates an example of a TAI list 600 with a third type (e.g., type of list “10”) that includes TAIs belonging to different PLMNs, in accordance with some embodiments. In some embodiments, the TAIs and associated TAIs of TAI list 600 may be individually indicated by respective fields. A PLMN may correspond to an MCC+MNC combination. In an example, as shown in FIG. 6, for type of list=“10” and number of elements=k: for j=1, . . . , k, octets 7j−5 to 7j−3 contain the MCC+MNC, and octets 7j−1 to 7j+1 contain the TAC of the j-th TAI belonging to the partial list. In an example, if the list of TAIs belonging to different PLMNs is used, the PLMNs included in the list may be required to be present in the list of equivalent PLMNs.

Similar to the IE 200, the TAI lists 400, 500, and/or 600 may include one or more flags to indicate whether respective services (such as IMS-voice, IMS-video, and/or SMS) are supported by the one or more TAIs.

Note that the TAI lists 400, 500, and 600 are illustrated to include TACs for 5G tracking areas (e.g., which may be represented by 3 octets). Similar TAI lists may be used for 4G tracking areas, e.g., including TACs represented by 2 octets.

The UE may detect the TAI broadcasted by a cell (e.g., in a master information block (MIB) and/or SIB). If the TAI broadcasted by the cell corresponds to one of the TAIs indicated by the IE 300 (e.g., as stored in memory of the UE), the UE will consider the cell to be a satellite cell (e.g., a satellite E-UTRAN cell or a satellite NG-RAN cell).

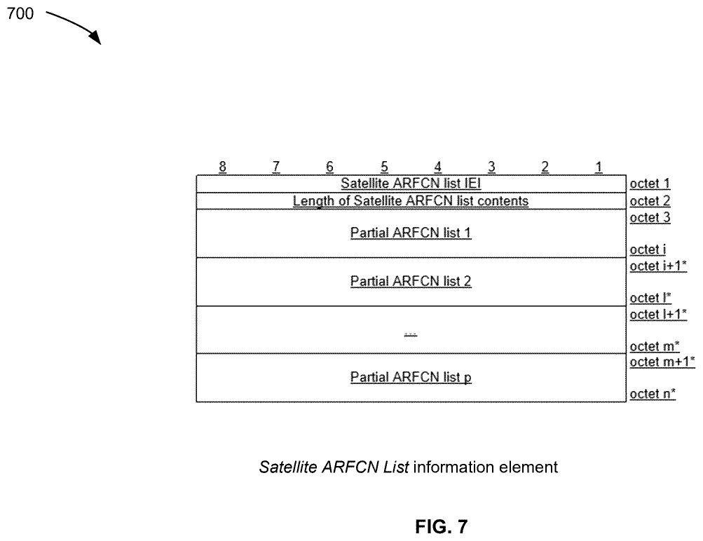

FIG. 7 illustrates an example IE 700 to indicate one or more carrier frequencies (e.g., ARFCNs) designated for satellite cells, in accordance with some embodiments. In an example, the IE 700 may be referred to as a “satellite ARFCN list” IE.

The IE 700 may include one or more lists of ARFCNs that are reserved for satellite cells. In an example, the one or more lists of ARFCNs may correspond to one or more respective PLMN IDs. The IE 700 may or may not indicate the PLMN ID associated with a list of ARFCNs. For example, the PLMN may be implicitly indicated to correspond to the PLMN ID from which the IE 700 is received. The one or more ARFCN lists of IE 700 may indicate consecutive and/or non-consecutive ARFCNs. If the UE detects a cell in a carrier frequency indicated in the list of ARFCNs associated with the PLMN ID of the cell, the UE considers the cell to be a satellite cell. In some embodiments, the IE 700 may include multiple ARFCN lists, e.g., referred to as partial ARFCN lists.

The ARFCN lists may include a field to indicate a type of list (e.g., similar to the type of list described above for TAI lists 400, 500, and/or 600). The type of list may indicate the contents and/or format of the ARFCN list. For example, the type of list may indicate that the ARFCN list includes non-consecutive ARFCN values, consecutive ARFCN values, or both. Additionally, or alternatively, the type of list may indicate whether the ARFCN list includes ARFCNs from one PLMN or different PLMNs.

The ARFCN lists may further include a number of elements field that indicates a number of ARFCNs and/or associated fields in the ARFCN list. In an example, the type of list field and the number of elements field may be included in the first octet (octet 1) of the ARFCN list.

The UE may store the one or more ARFCN lists in memory (e.g., non-volatile memory). In an example, the IE 700 may be a type 4 IE with a minimum length of 9 octets and a maximum length of 114 octets. In some embodiments, the IE 700 may be limited to a maximum number (e.g., 16) of ARFCNs. If the IE 700 includes more than the maximum number of ARFCNs, the UE may store the first number of ARFCNs equal to the maximum number and ignore the remaining ARFCNs and/or octets of the IE 700.

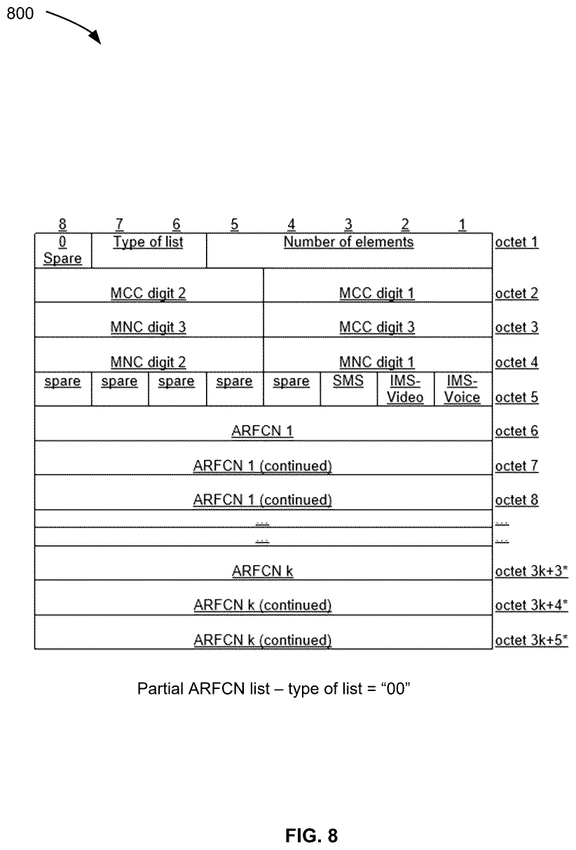

FIG. 8 illustrates an example of an ARFCN list 800 of a first type (e.g., type of list “00”) with individually indicated ARFCNs (e.g., non-consecutive ARFCNs) of a same PLMN, in accordance with some embodiments. In an example, as shown in FIG. 8, for type of list=“00” and number of elements=k, octets 2 to 4 contain the MCC+MNC, and for j=1, . . . , k: octets 3j+3 to 3j+5 contain the ARFCN of the j-th ARFCN belonging to the partial list.

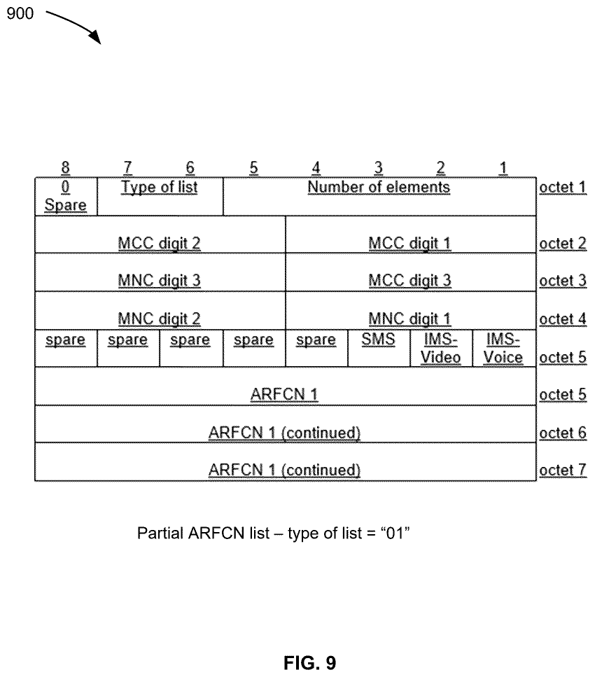

FIG. 9 illustrates an example of an ARFCN list 900 of a second type (e.g., type of list “01”) with consecutive ARFCNs belonging to the same PLMN, in accordance with some embodiments. In an example, as shown in FIG. 9, for type of list=“01” and number of elements=k: octets 2 to 4 contain the MCC+MNC, and octets 5 to 7 contain the ARFCN of the first ARFCN belonging to the partial list. The ARFCN values of the other k−1 ARFCNs are ARFCN+1, ARFCN+2, . . . , ARFCN+k−1.

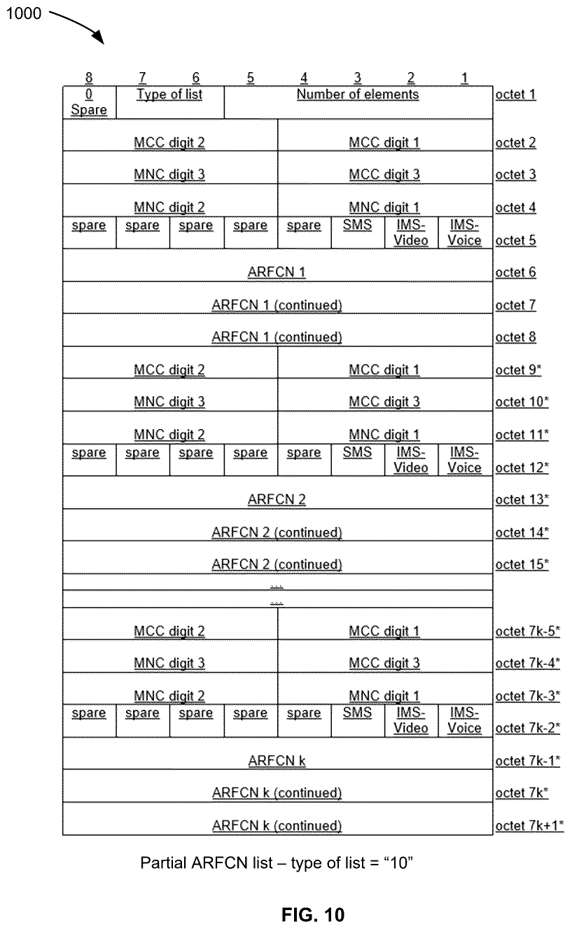

FIG. 10 illustrates an example of an ARFCN list 1000 of a third type (e.g, type of list “10”) with ARFCNs belonging to different PLMNs, in accordance with some embodiments. In some embodiments, the ARFCNs and associated PLMNs of ARFCN list 1000 may be individually indicated by respective fields. A PLMN may correspond to a MCC+MNC combination. In an example, as shown in FIG. 10, for type of list=“10” and number of elements=k: for j=1, . . . , k, octets 7j−5 to 7j−3 contain the MCC+MNC, and octets 7j−1 to 7j+1 contain the ARFCN of the j-th ARFCN belonging to the partial list. In an example, if the list of ARFCNs belonging to different PLMNs is used, the PLMNs included in the list may be required to be present in the list of equivalent PLMNs.

In some embodiments, the ARFCN lists 800, 900, and/or 1000 may include one or more flags to indicate whether respective services (such as IMS-voice, IMS-video, and/or SMS) are supported by the one or more ARFCNs.

As previously discussed, the list of PLMN IDs, TAIs, and/or ARFCNs designated for satellite cells (such as IE 200, IE 300 (e.g. including one or more TAI lists 400, 500, and/or 600), and/or IE 700 (e.g., including one or more ARFCN lists 800, 900, and/or 1000)) may be included in one or more mobility management messages transmitted by the network. For example, one or more EPS mobility management messages defined by Sections 5 and/or 8.2 of 3GPP TS 24.301 may be modified to include a satellite-related IE as described herein (e.g., IE 200, 300, and/or 700). Examples of an EPS mobility management message that may include the IE include an attach accept message, a tracking area update accept message, a GUTI reallocation command, a detach request message (e.g., for network-initiated detach procedure), and/or a detach accept message (e.g., for UE-initiated detach procedure).

In another example, one or more 5GS mobility management messages defined by Sections 5 and/or 8.2 of 3GPP TS 24.501 may be modified to include the satellite-related IE described herein (e.g., IE 200, 300, and/or 700). Examples of a 5GS mobility management message that may include the IE include a registration accept message, a configuration update command, a deregistration request message (e.g., for network-initiated deregistration procedure), and/or a deregistration accept message (e.g., for UE-initiated deregistration procedure).

While embodiments are primarily described with respect to 4G and 5G NAS protocols, the satellite-related IE(s) may additionally or alternatively be added to prior generation (e.g., 2G global system for mobile communications (GSM) EDGE radio access network (GERAN) and/or 3G universal mobile telecommunications system (UMTS) terrestrial radio access network (UTRAN)) NAS messages and/or future generation (e.g., 6G) NAS messages. Examples of 2G NAS messages that may include the IE(s) described herein may include a location updating accept message, mobility management information message, and/or international mobile subscriber identity (IMSI) detach indication message. Examples of 3G NAS messages that may include the IE(s) described herein include an attach accept message, detach accept message (for mobile-originating detach procedure), detach request message (for mobile-terminated detach procedure), routing area update accept message, and/or packet temporary mobile subscriber identity (P-TMSI) reallocation command message.

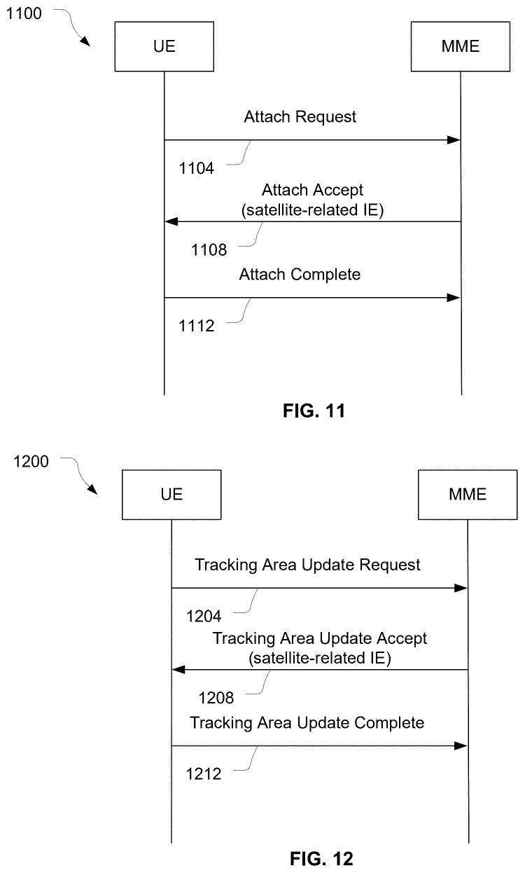

FIG. 11 illustrates an example of an attach procedure 1100 (“procedure 1100”) in accordance with some embodiments. Aspects of the procedure 1100 may be performed by a UE, a network device (e.g., an MME), and/or components thereof. The attach procedure 1100 may be used in an EPS (e.g., LTE) network.

At 1104, the UE may transmit an attach request to the network (e.g., MME). The attach request may include information associated with the UE, one or more parameters associated with the requested attach, and/or one or more services requested by the UE. At 1108, the network (e.g., MME) may transmit an attach accept message to the UE. The attach accept message may indicate that the UE is permitted to connect with the network. The attach accept message may include a satellite-related IE (e.g., IE 200, 300, and/or 700) to enable the UE to identify satellite cells of the network as described herein. The UE may perform cell selection and/or re-selection in the network based on the satellite-related IE.

In some embodiments, the UE may transmit, at 1112, an attach complete message to the network based on the attach accept message.

FIG. 12 illustrates an example tracking area update request procedure 1200 (“procedure 1200”) in accordance with some embodiments. Aspects of the procedure 1200 may be performed by a UE, a network device (e.g., an MME), and/or components thereof. The procedure 1200 may be used in an EPS (e.g., LTE) network. The UE may initiate the procedure periodically and/or based on one or more triggers.

At 1204, the UE may transmit a tracking area update request message to the network (e.g., MME). The tracking area update request message may update the TAI associated with the UE. At 1208, the network (e.g., MME) may transmit a tracking area update accept message to the UE. The tracking area update accept message may include a satellite-related IE (e.g., IE 200, 300, and/or 700) to enable the UE to identify satellite cells of the network as described herein. The UE may perform cell selection and/or re-selection in the network based on the satellite-related IE.

In some embodiments, the UE may transmit, at 1212, tracking area update complete message to the network based on the tracking area update accept message.

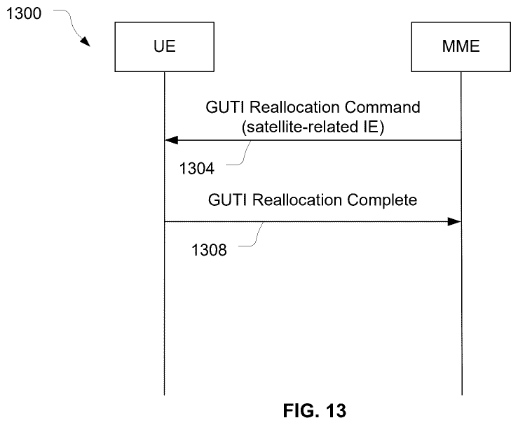

FIG. 13 illustrates an example of a GUTI reallocation procedure 1300 (“procedure 1300”) in accordance with some embodiments. Aspects of the procedure 1300 may be performed by a UE, a network device (e.g., an MME), and/or components thereof. The procedure 1300 may be used in an EPS (e.g., LTE) network.

At 1304, the network (e.g., MME) may transmit a GUTI reallocation command to the UE. The GUTI reallocation command may include a satellite-related IE (e.g., IE 200, 300, and/or 700) to enable the UE to identify satellite cells of the network as described herein. The GUTI reallocation command may further include one or more parameters associated with a GUTI, such as a TAI list.

At 1308, the UE may transmit a GUTI reallocation complete message to the network (e.g., the MME).

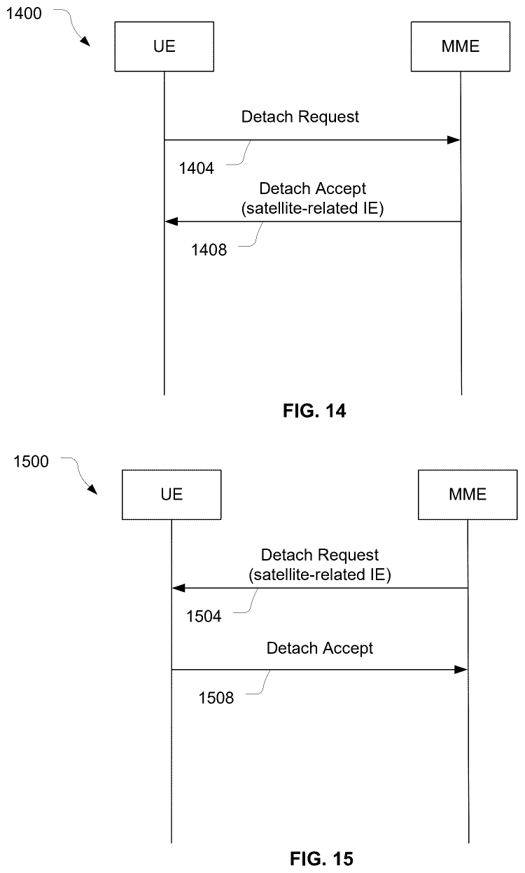

FIG. 14 illustrates an example of a UE-initiated detach procedure 1400 (“procedure 1400”) in accordance with some embodiments. Aspects of the procedure 1400 may be performed by a UE, a network device (e.g., an MME), and/or components thereof. The procedure 1400 may be used in an EPS (e.g., LTE) network.

At 1404, the UE may transmit a detach request to the network (e.g., MME). At 1408, the network (e.g., MME) may transmit a detach accept message to the UE. The detach accept message may include a satellite-related IE (e.g., IE 200, 300, and/or 700) to enable the UE to identify satellite cells of the network as described herein. The UE may sever its connection with the network based on the detach procedure 1400.

The UE may use the satellite-related information in the satellite-related IE to select the network or another network for a subsequent network connection. For example, the satellite-related IE may indicate one or more PLMN IDs that are designated for satellite cells. The UE may prioritize or de-prioritize connecting to one of the indicated PLMN IDs, e.g., as further described herein.

FIG. 15 illustrates an example of a network-initiated detach procedure 1500 (“procedure 1500”) in accordance with some embodiments. Aspects of the procedure 1500 may be performed by a UE, a network device (e.g., an MME), and/or components thereof. The procedure 1500 may be used in an EPS (e.g., LTE) network.

At 1504, the network (e.g., MME) may transmit a detach request to the UE. The detach request may include a satellite-related IE (e.g., IE 200, 300, and/or 700) to enable the UE to identify satellite cells of the network as described herein. At 1508, the UE may transmit a detach accept message to the network. The UE may sever its connection with the network based on the detach procedure 1500.

The UE may use the satellite-related information in the satellite-related IE to select the network or another network for a subsequent network connection, e.g., as described above with respect to procedure 1400.

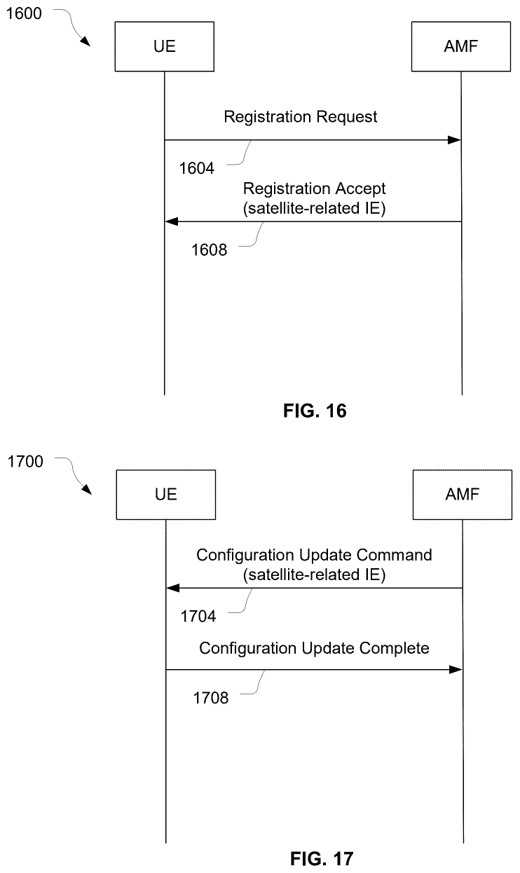

FIG. 16 illustrates an example registration procedure 1600 (“procedure 1600”) in accordance with some embodiments. Aspects of the procedure 1600 may be performed by a UE, a network device (e.g., an AMF), and/or components thereof. The registration procedure 1600 may be used in a 5GS (e.g., NR) network. Aspects of the registration procedure 1600 may be similar to the attach procedure 1100 described above.

At 1604, the UE may transmit a registration request to the network (e.g., AMF). The registration request may include information associated with the UE, one or more parameters associated with the requested registration, and/or one or more services requested by the UE. At 1608, the network (e.g., AMF) may transmit a registration accept message to the UE. The registration accept message may indicate that the UE is permitted to connect with the network. The registration accept message may include a satellite-related IE (e.g., IE 200, 300, and/or 700) to enable the UE to identify satellite cells of the network as described herein. The UE may perform cell selection and/or re-selection in the network based on the satellite-related IE.

In some embodiments, the UE may transmit a registration complete message to the network based on the registration accept message. In other embodiments, the UE may not transmit a registration complete message.

FIG. 17 illustrates an example of a configuration update procedure 1700 (“procedure 1700”) in accordance with some embodiments. Aspects of the procedure 1700 may be performed by a UE, a network device (e.g., an AMF), and/or components thereof. The procedure 1700 may be used in a 5GS (e.g., NR) network.

At 1704, the network (e.g., AMF) may transmit a configuration update command to the UE. The configuration update command may include a satellite-related IE (e.g., IE 200, 300, and/or 700) to enable the UE to identify satellite cells of the network as described herein. The UE may perform cell selection and/or re-selection in the network based on the satellite-related IE.

In some embodiments, the UE may transmit, at 1708, a configuration update complete message. In other embodiments, the UE may not transmit a configuration update complete message.

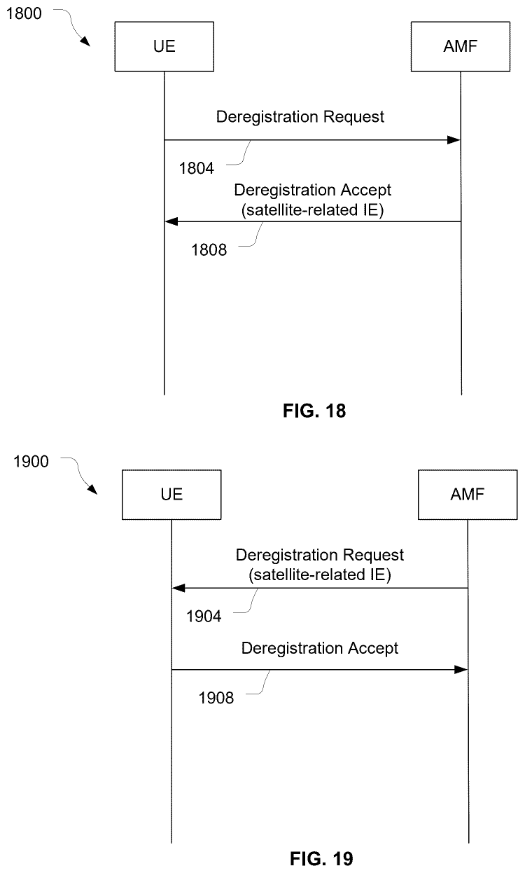

FIG. 18 illustrates an example of a UE-initiated deregistration procedure 1800 (“procedure 1800”) in accordance with some embodiments. Aspects of the procedure 1800 may be performed by a UE, a network device (e.g., an AMF), and/or components thereof. The procedure 1800 may be used in a 5GS (e.g., NR) network.

At 1804, the UE may transmit a deregistration request to the network (e.g., AMF). At 1808, the network (e.g., AMF) may transmit a deregistration accept message to the UE. The deregistration accept message may include a satellite-related IE (e.g., IE 200, 300, and/or 700) to enable the UE to identify satellite cells of the network and/or another network as described herein. The UE may sever its connection with the network based on the deregistration procedure 1800.

The UE may use the satellite-related information in the satellite-related IE to select the network or another network for a subsequent network connection. For example, the satellite-related IE may indicate one or more PLMN IDs that are designated for satellite cells. The UE may prioritize or de-prioritize connecting to one of the indicated PLMN IDs, e.g., as further described herein.

FIG. 19 illustrates an example of a network-initiated deregistration procedure 1900 (“procedure 1900”) in accordance with some embodiments. Aspects of the procedure 1900 may be performed by a UE, a network device (e.g., an AMF), and/or components thereof. The procedure 1900 may be used in a 5GS (e.g., NR) network.

At 1904, the network (e.g., AMF) may transmit a deregistration request to the UE. The deregistration request message may include a satellite-related IE (e.g., IE 200, 300, and/or 700) to enable the UE to identify satellite cells of the network and/or another network as described herein. At 1908, the UE may transmit a deregistration accept message to the network. The UE may sever its connection with the network based on the deregistration procedure 1900.

The UE may use the satellite-related information in the satellite-related IE to select the network or another network for a subsequent network connection.

It is noted that FIG. 11-19 illustrate non-exhaustive examples of mobility management procedures and associated messages that may be used to transmit satellite-related information to the UE as described herein. Other mobility management procedures and/or associated messages may additionally or alternatively be used to transmit satellite-related information to the UE in accordance with various embodiments herein.

Embodiments herein further provide one or more prioritization rules that may be used by the UE for cell and/or PLMN selection based on whether the cell and/or PLMN is a satellite cell and/or PLMN. The prioritization rules may be further based on one or more services supported by the cell and/or PLMN. The UE may identify satellite PLMNs and/or cells based on the associated PLMN, TAI, and/or ARFCN as described herein.

For example, if the satellite PLMN or cell does not support all services required (or supported) by the UE, the UE may select the satellite PLMN or cell with low priority, e.g., only if no other access network is available that provides all the services. In an example, the UE may be configured by the user with a usage setting of “voice centric.” If the satellite PLMN or cell is indicated as not supporting voice service, then the UE may assign a low priority to the satellite PLMN or cell.

In an example, if the satellite access network is deployed with a separate PLMN code, the UE may select the satellite PLMN which does not provide all required services with lowest priority during PLMN selection (e.g., as defined in 3GPP TS 23.122). The PLMN selection rules in TS 23.122 may be updated to provide that a satellite PLMN with partial service support shall be selected only if no other allowable PLMN supporting all services (or all required services) is available. For cell selection and re-selection, if the network operator does not configure cell re-selection between the satellite PLMN and the terrestrial PLMN, no modification for cell (re-) selection may be required, as a transition between the satellite and the terrestrial PLMN is done via PLMN selection. If the network operator configures cell re-selection between the satellite and the terrestrial cells, an equivalent PLMN (EPLMN) list may be configured and the ARFCN of the satellite cells may be configured with a re-selection priority which is the lowest used in this network. Note that the network may determine the one or more services that are considered “required services” based on the usage setting of the UE (e.g., “voice centric”, “data centric”, etc.) which may be signaled by the UE such as during the attach procedure, tracking area update procedure, and/or registration procedure.

In another example, if TAI is used to identify the satellite access technology, the UE may check the TAI of the cells associated with a PLMN that was found during a PLMN scan. The satellite cells may be deployed with the same PLMN ID and a different TAI than a terrestrial access network. If the satellite cell does not support all required services, the UE may select the PLMN and TAI combination of the satellite cell with the lowest priority during PLMN selection. A satellite cell that supports some but not all required services (partial service support) may be selected only if no other PLMN and TAI combination is available that supports all of the services.

In another example, if ARFCN is used to identify the satellite access technology (e.g., NTN cells), the UE may check the ARFCN of the cells associated with a PLMN that was found during a PLMN scan. The satellite cells may be deployed with the same PLMN ID and a different ARFCN than a terrestrial access network (e.g., one or more terrestrial cells). In some embodiments, the satellite cells may have the same TAI as the terrestrial access network. If the satellite cell does not support all required services, the UE may select the PLMN and ARFCN combination of the satellite cell with the lowest priority during PLMN selection. A satellite cell that supports some but not all required services (partial service support) may be selected only if no other PLMN and ARFCN combination is available that supports all of the services.

In some embodiments, the selection priority of the satellite PLMN and/or cells may be further based on signal quality (e.g., with respect to multiple satellite cell PLMNs and/or cells that would otherwise have the same priority).

In an example, the automatic network selection mode procedure in Section 4.4.3.1.1 of TS 23.122 may be updated to incorporate satellite access technology, such as shown below with updates in underline:

### 4.4.3.1.1 Automatic Network Selection Mode Procedure

The MS selects and attempts registration on other PLMN/access technology combinations, if available and, for bullets i, ii, iii, iv, v, allowable, in the following order:
i) either the HPLMN (if the EHPLMN list is not present or is empty) or the highest priority EHPLMN that is available (if the EHPLMN list is present);
ii) each PLMN/access technology combination in the “User Controlled PLMN Selector with Access Technology” data file in the SIM (in priority order);
iii) each PLMN/access technology combination in the “Operator Controlled PLMN Selector with Access Technology” data file in the SIM (in priority order) or stored in the ME (in priority order);
iv) other PLMN/access technology combinations with received high quality signal in random order;
NOTE 1: High Quality Signal is Defined in the Appropriate AS Specification
v) other PLMN/access technology combinations in order of decreasing signal quality.
SAT_iii) each PLMN/satellite access technology combination, in the “Operator Controlled PLMN Selector for satellite Access Technology” data file in the SIM (in priority order) or stored in the ME (in priority order);
SAT_iv) other PLMN/satellite access technology combinations with service restrictions, with received high quality signal in random order;
NOTE 1A: High quality signal is defined in the appropriate AS specification.
SAT_v) other PLMN/satellite access technology combinations with service restrictions, in order of decreasing signal quality.
vi) PLMN/NG-RAN combinations for any forbidden PLMNs broadcasting the PLMN ID of the UE determined PLMN with disaster condition or broadcasting the disaster related indication and matching the below conditions:
   a) if the indication of ‘applicability of “lists of PLMN(s) to be used in disaster condition” provided by a VPLMN’ is set to true:
      each PLMN in the “list of PLMN(s) to be used in disaster condition” stored in the ME which is associated with the PLMN ID of the UE determined PLMN with disaster condition, if any, ordered based on this list; otherwise
      if the ME does not have a stored “list of PLMN(s) to be used in disaster condition” associated with the PLMN ID of the UE determined PLMN with disaster condition, each PLMN in the “list of PLMN(s) to be used in disaster condition” stored in the ME which is associated with the PLMN ID of the HPLMN, if any, ordered based on this list.
   b) if the indication of ‘applicability of “lists of PLMN(s) to be used in disaster condition” provided by a VPLMN’ is set to false:
      each PLMN in the “list of PLMN(s) to be used in disaster condition” stored in the ME which is associated with the HPLMN, if any, ordered based on this list.
vii) PLMN/NG-RAN combinations for other forbidden PLMNs broadcasting the PLMN ID of the UE determined PLMN with disaster condition or broadcasting the disaster related indication, in random order.
In steps SAT_iv) and SAT_v) a PLMN/satellite access technology combination with service restrictions is a PLMN/access technology combination which identifies a satellite access according to one of the information elements “Satellite PLMN list” , “Satellite TAI list” or “ Satellite ARFCN list ” provided by the network and which does not support all the services required by the MS.
In steps i) to v) the UE shall exclude PLMN/satellite access technology combinations with service restrictions and PLMN/satellite access technology combinations included in the “Operator Controlled PLMN Selector for satellite Access Technology”.

Note that in some embodiments, the home network operator of the UE may preconfigure whether one or more features described herein are activated or deactivated for the UE. For example, the SIM of the UE may store a flag to indicate whether some or all features related to satellite-aware PLMN and/or cell selection as described herein (such as use of the IE in the mobility management message and/or associated priority rules) are activated or deactivated. This flag may enable the home network operator to prevent another network operator from controlling priority of PLMN and/or cell selection of the UE.

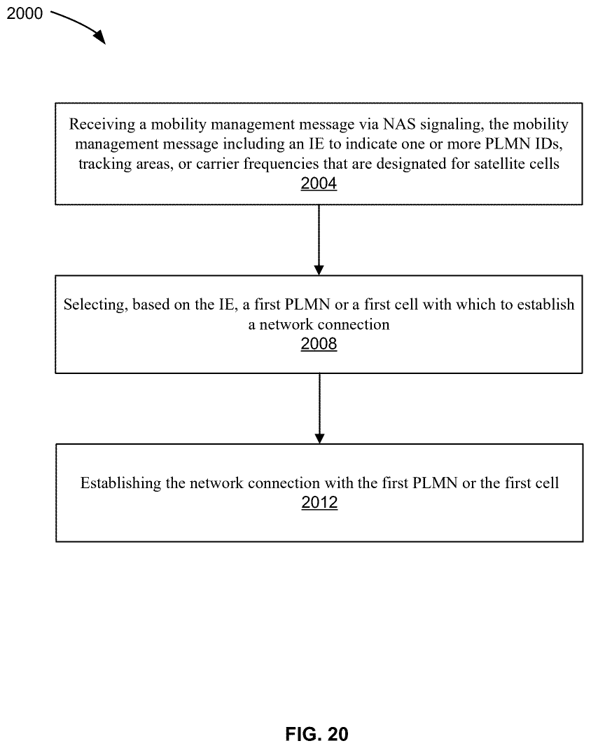

FIG. 20 illustrates an example of an operational flow/algorithmic structure 2000 for satellite-aware PLMN and/or cell selection, in accordance with some embodiments. The operational flow/algorithmic structure 2000 can be implemented by a UE (e.g., performed by components thereof including, for example, an apparatus of the UE, where the apparatus includes processing circuitry; a modem is an example of such an apparatus). The UE can be any of the UEs described herein. In some embodiments, the operational flow/algorithmic structure 2000 may be implemented by executing instructions stored in a tangible, non-transitory, computer-readable storage medium, such as a memory of the UE. While the operational flow/algorithmic structure 2000 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 2000 may include, at 2004, receiving a mobility management message via NAS signaling, the mobility management message including an IE to indicate one or more PLMN IDs, tracking areas, or carrier frequencies that are designated for satellite cells. In an example, the IE may include a list of the one or more PLMN IDs that are designated for the satellite cells. In another example, the IE may include a list of one or more TAIs to indicate the one or more tracking areas. In some embodiments, the one or more TAIs may correspond to multiple TAIs and the IE may include a field to indicate whether the TAIs are consecutive or non-consecutive and/or whether the TAIs belong to one PLMN or different PLMNs. In another example, the IE may include a list of one or more ARFCNs to indicate the one or more carrier frequencies. In some embodiments, the one or more ARFCNs may correspond to multiple ARFCNs and the IE may include a field to indicate whether the ARFCNs are consecutive or non-consecutive and/or whether the ARFCNs belong to one PLMN or different PLMNs.

In some embodiments, the mobility management message may be received from an MME or an AMF. The mobility management message may correspond to, for example, an attach accept message, a tracking area update accept message, a GUTI reallocation command, a detach request message, a detach accept message, a registration accept message, a configuration update command, a deregistration request message, or a deregistration accept message.

The operational flow/algorithmic structure 2000 may further include, at 2008, selecting, based on the IE, a first PLMN or a first cell with which to establish a network connection.

The operational flow/algorithmic structure 2000 may further include, at 2012, establishing the network connection with the first PLMN or the first cell.

For example, the first PLMN or first cell may be selected based on the priority rules described herein. In some embodiments, the IE may further indicate one or more services supported in the one or more PLMN IDs, tracking areas, or carrier frequencies. The first PLMN or first cell may be selected further based on the supported services. For example, the UE may prioritize PLMNs or cells that support one or more required services of the UE. The one or more services may include, for example, voice service, video service, and/or SMS.

In an example, the UE may identify, based on the IE, that the first PLMN is a satellite PLMN or the first cell is a satellite cell. Based on the identification, the UE may apply one or more satellite-specific protocol adaptations in the NAS signaling towards the first PLMN or the first cell. For example, the one or more satellite-specific protocol adaptations may include one or more of an adaptation of NAS timer values, support of a satellite-specific mobility management reject cause, and/or support of multiple tracking area codes (TACs) per cell.

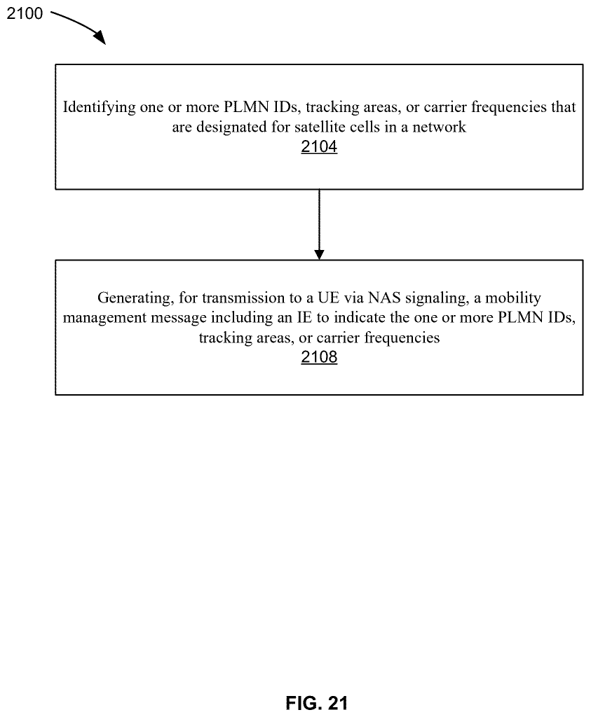

FIG. 21 illustrates an example of another operational flow/algorithmic structure 2100 for satellite-aware PLMN and/or cell selection, in accordance with some embodiments. The operational flow/algorithmic structure 2100 can be implemented by a network device (e.g., performed by components thereof including, for example, an apparatus of the network device, where the apparatus includes processing circuitry; a modem is an example of such an apparatus). The network device can be any of the network devices described herein, such as an MME and/or an AMF of a core network. In some embodiments, the operational flow/algorithmic structure 2100 may be implemented by executing instructions stored in a tangible, non-transitory, computer-readable storage medium, such as a memory of the network device. While the operational flow/algorithmic structure 2100 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 2100 includes, at 2104, identifying one or more PLMN IDs, tracking areas, or carrier frequencies that are designated for satellite cells in a network.

The operational flow/algorithmic structure 2100 may further include, at 2108, generating, for transmission to a UE via NAS signaling, a mobility management message including an IE to indicate the one or more PLMN IDs, tracking areas, or carrier frequencies.

In an example, the IE may include a list of the one or more PLMN IDs that are designated for the satellite cells. In another example, the IE may include a list of one or more TAIs to indicate the one or more tracking areas. In some embodiments, the one or more TAIs may correspond to multiple TAIs and the IE may include a field to indicate whether the TAIs are consecutive or non-consecutive and/or whether the TAIs belong to the same PLMN or different PLMNs. In another example, the IE may include a list of one or more ARFCNs to indicate the one or more carrier frequencies. In some embodiments, the one or more ARFCNs may correspond to multiple ARFCNs and the IE may include a field to indicate whether the ARFCNs are consecutive or non-consecutive and/or whether the ARFCNs belong to the same ARFCN or different ARFCNs.

The mobility management message may correspond to, for example, an attach accept message, a tracking area update accept message, a GUTI reallocation command, a detach request message, a detach accept message, a registration accept message, a configuration update command, a deregistration request message, or a deregistration accept message.

In some embodiments, the IE may further indicate one or more services supported in the one or more PLMN IDs, tracking areas, or carrier frequencies. The one or more services may include, for example, voice service, video service, and/or SMS.

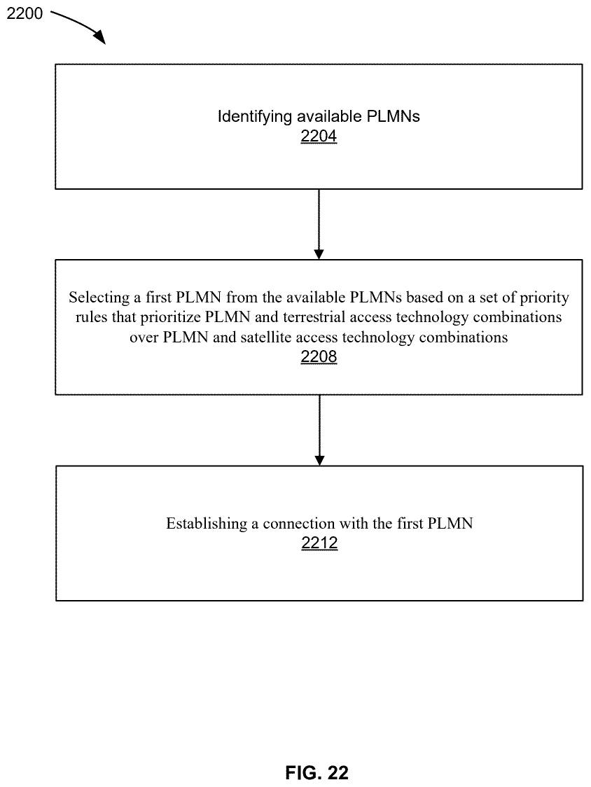

FIG. 22 illustrates another example of an operational flow/algorithmic structure 800 for satellite-aware PLMN and/or cell selection, in accordance with some embodiments. The operational flow/algorithmic structure 2200 can be implemented by a UE (e.g., performed by components thereof including, for example, an apparatus of the UE, where the apparatus includes processing circuitry; a modem is an example of such an apparatus). The UE can be any of the UEs described herein. In some embodiments, the operational flow/algorithmic structure 2200 may be implemented by executing instructions stored in a tangible, non-transitory, computer-readable storage medium, such as a memory of the UE. While the operational flow/algorithmic structure 2200 is described using steps in a specific sequence, it should be understood that the present disclosure contemplates that the described steps may be performed in different sequences than the sequence illustrated, and certain described steps may be omitted or not performed altogether. Further, one or more operations of the operational flow/algorithmic structure 2200 can include one or more operations of the operational flow/algorithmic structure 2000.

In an example, the operational flow/algorithmic structure 2200 includes, at 2204, identifying available PLMNs. For example, the UE may perform a PLMN search to identify the available PLMNs.

The operational flow/algorithmic structure 2200 may further include, at 2208, selecting a first PLMN from the available PLMNs based on a set of priority rules that prioritize PLMN and terrestrial access technology combinations over PLMN and satellite access technology combinations. The UE may access the priority rules from a SIM of the UE and/or another storage medium such as non-volatile memory.

The operational flow/algorithmic structure 2200 may further include, at 2212, establishing a connection with the first PLMN.

In an example, the priority rules may be based further on service restrictions of the PLMN and satellite access technology combinations. The service restrictions may be based on one or more services that are supported or not supported by the respective PLMN and satellite access technology combinations.

In another example, the UE may access an operator-controlled list of PLMNs for satellite access technology that indicates one or more of the PLMN and satellite access technology combinations in priority order. For example, the operator-controlled list of PLMNs may be stored in the SIM of the UE and/or another storage medium such as non-volatile memory. The priority rules may prioritize or de-prioritize the one or more PLMN and satellite access technology combinations included in the operator-controlled list of PLMNs over other PLMN and satellite access technology combinations.

In an example, the UE may identify the PLMN and satellite access technology combinations based on an IE in an NAS message, such as a mobility management message. For example, the IE may indicate one or more PLMN IDs, tracking areas, or carrier frequencies that are reserved for satellite access technology as described herein.

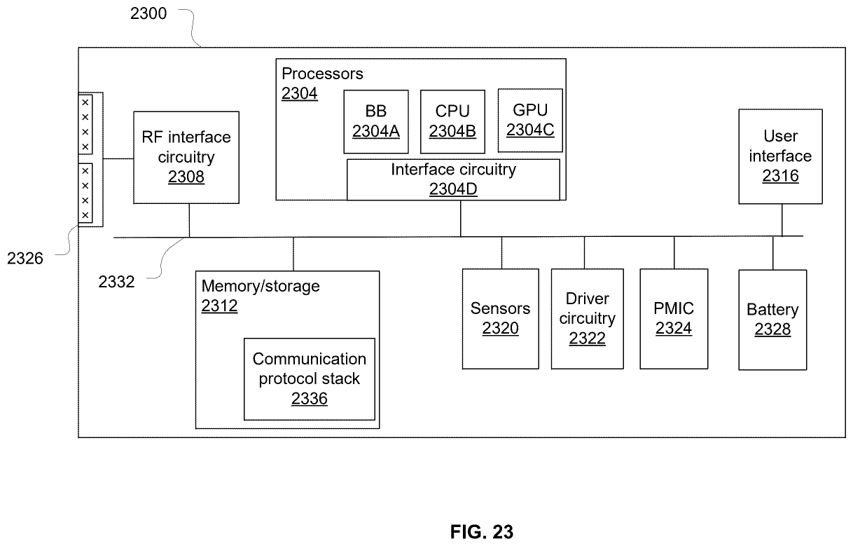

FIG. 23 illustrates a UE 2300, in accordance with some embodiments. The UE 2300 may be similar to and substantially interchangeable with any of the UEs described herein above. Particularly, the UE 2300 can support satellite-aware PLMN and/or cell selection as described herein.

Similar to that described above with respect to UE 104, the UE 2300 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 2300 may include processors 2304, RF interface circuitry 2308, memory/storage 2312, user interface 2316, sensors 2320, driver circuitry 2322, power management integrated circuit (PMIC) 2324, and battery 2328. The components of the UE 2300 may be implemented as integrated circuits (ICs), portions thereof, discrete electronic devices, or other modules, logic, hardware, software, firmware, or a combination thereof. The block diagram of FIG. 23 is intended to show a high-level view of some of the components of the UE 2300. However, some of the components shown may be omitted, additional components may be present, and different arrangements of the components shown may occur in other implementations.

The components of the UE 2300 may be coupled with various other components over one or more interconnects 2332, which may represent any type of interface, input/output, bus (local, system, or expansion), transmission line, trace, optical connection, etc. that allows various circuit components (on common or different chips or chipsets) to interact with one another.

The processors 2304 may include processor circuitry, such as baseband processor circuitry (BB) 2304A, central processor unit circuitry (CPU) 2304B, and graphics processor unit circuitry (GPU) 2304C. The processors 2304 may include any type of circuitry or processor circuitry that executes or otherwise operates computer-executable instructions, such as program code, software modules, or functional processes from memory/storage 2312 to cause the UE 2300 to perform operations as described herein.

In some embodiments, the baseband processor circuitry 2304A may access a communication protocol stack 2336 in the memory/storage 2312 to communicate over a 3GPP compatible network. In general, the baseband processor circuitry 2304A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 2308.

The baseband processor circuitry 2304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 2312 may include any type of volatile or non-volatile memory that may be distributed throughout the UE 2300. In some embodiments, some of the memory/storage 2312 may be located on the processors 2304 themselves (for example, L1 and L2 cache), while other memory/storage 2312 is external to the processors 2304 but accessible thereto via a memory interface. The memory/storage 2312 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 2308 may include transceiver circuitry and a radio frequency front end module (RF FEM) that allows the UE 2300 to communicate with other devices over a radio access network. The RF interface circuitry 2308 may include various elements arranged in transmit or receive paths. These elements may include, for example, switches, mixers, amplifiers, filters, synthesizer circuitry, control circuitry, etc.

In the receive path, the RF FEM may receive a radiated signal from an air interface via an antenna 2350 and proceed to filter and amplify (with a low-noise amplifier) the signal. The signal may be provided to a receiver of the transceiver that down-converts the RF signal into a baseband signal that is provided to the baseband processor of the processors 2304.

In the transmit path, the transmitter of the transceiver up-converts the baseband signal received from the baseband processor and provides the RF signal to the RF FEM. The RFEM may amplify the RF signal through a power amplifier prior to the signal being radiated across the air interface via the antenna 2350.

In various embodiments, the RF interface circuitry 2308 may be configured to transmit/receive signals in a manner compatible with NR access technologies.

The antenna 2350 may include a number of antenna elements that each convert electrical signals into radio waves to travel through the air and to convert received radio waves into electrical signals. The antenna elements may be arranged into one or more antenna panels. The antenna 2350 may have antenna panels that are omnidirectional, directional, or a combination thereof to enable beamforming and multiple input, multiple output communications. The antenna 2350 may include microstrip antennas, printed antennas fabricated on the surface of one or more printed circuit boards, patch antennas, phased array antennas, etc. The antenna 2350 may have one or more panels designed for specific frequency bands including bands in FR1 or FR2.

The user interface circuitry 2316 includes various input/output (I/O) devices designed to enable user interaction with the UE 2300. The user interface 2316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 2300.

The sensors 2320 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 2322 may include software and hardware elements that operate to control particular devices that are embedded in the UE 2300, attached to the UE 2300, or otherwise communicatively coupled with the UE 2300. The driver circuitry 2322 may include individual drivers allowing other components to interact with or control various input/output (I/O) devices that may be present within, or connected to, the UE 2300. For example, driver circuitry 2322 may include a display driver to control and allow access to a display device, a touchscreen driver to control and allow access to a touchscreen interface, sensor drivers to obtain sensor readings of sensor circuitry 2320 and control and allow access to sensor circuitry 2320, drivers to obtain actuator positions of electro-mechanic components or control and allow access to the electro-mechanic components, a camera driver to control and allow access to an embedded image capture device, audio drivers to control and allow access to one or more audio devices.

The PMIC 2324 may manage power provided to various components of the UE 2300. In particular, with respect to the processors 2304, the PMIC 2324 may control power-source selection, voltage scaling, battery charging, or DC-to-DC conversion.

In some embodiments, the PMIC 2324 may control, or otherwise be part of, various power saving mechanisms of the UE 2300. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 2300 may power down for brief intervals of time and thus save power. If there is no data traffic activity for an extended period of time, then the UE 2300 may transition off to an RRC_Idle state, where it disconnects from the network and does not perform operations, such as channel quality feedback, handover, etc. The UE 2300 goes into a very low power state and it performs paging where again it periodically wakes up to listen to the network and then powers down again. The UE 2300 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 2328 may power the UE 2300, although in some examples the UE 2300 may be mounted deployed in a fixed location and may have a power supply coupled to an electrical grid. The battery 2328 may be a lithium-ion battery, a metal-air battery, such as a zinc-air battery, an aluminum-air battery, a lithium-air battery, and the like. In some implementations, such as in vehicle-based applications, the battery 2328 may be a typical lead-acid automotive battery.

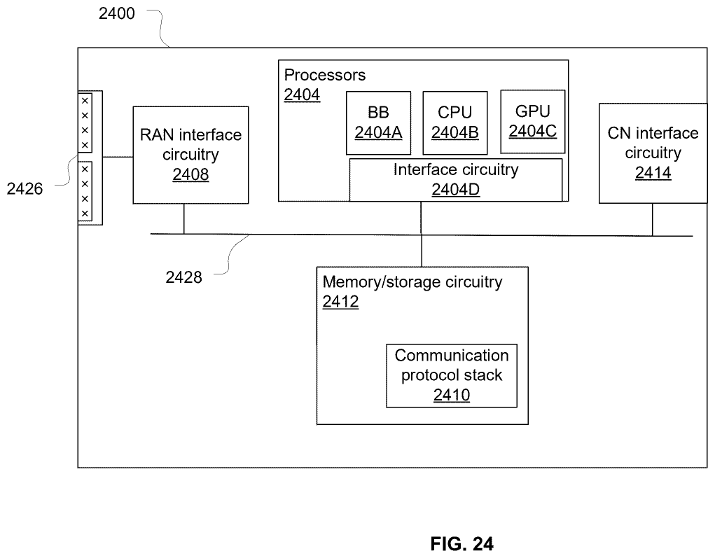

FIG. 24 illustrates a network device 2400 in accordance with some embodiments. The network device 2400 may be similar to, and substantially interchangeable with, the base station 108 and/or a component of the CN 112 (e.g., MME 114 and/or AMF 116). The network device 2400 can support satellite-aware PLMN and/or cell selection as described herein (e.g., transmission of an NAS message with an IE that includes satellite-related information to enable a UE to identify satellite cells).

The network device 2400 may include processors 2404, RF interface circuitry 2408 (if implemented as a base station), core network (CN) interface circuitry 2414, memory/storage circuitry 2412, and antenna structure 2426.

The components of the network device 2400 may be coupled with various other components over one or more interconnects 2428.

The processors 2404, RF interface circuitry 2408, memory/storage circuitry 2412 (including communication protocol stack 2410), antenna structure 2426, and interconnects 2428 may be similar to like-named elements shown and described with respect to FIG. 23.

The processors 2404 may include processor circuitry such as, for example, baseband processor circuitry (BB) 2404A, central processor unit circuitry (CPU) 2404B, and graphics processor unit circuitry (GPU) 2404C. The processors 2404 may include any type of circuitry or processor circuitry that executes or otherwise operates computer-executable instructions, such as program code, software modules, or functional processes from memory/storage circuitry 2412 to cause the network device 2400 to perform operations as described herein. The processors 2404 may also include interface circuitry 2404D to communicatively couple the processor circuitry with one or more other components of the network device 2400.

The CN interface circuitry 2414 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 2400 via a fiber optic or wireless backhaul. The CN interface circuitry 2414 may include one or more dedicated processors or FPGAs to communicate using one or more of the aforementioned protocols. In some implementations, the CN interface circuitry 2414 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method comprising: receiving a mobility management message via non-access stratum (NAS) signaling, the mobility management message including an information element (IE) to indicate one or more public land mobile network (PLMN) identities (IDs), tracking areas, or carrier frequencies that are designated for satellite cells; selecting, based on the IE, a first PLMN or a first cell with which to establish a network connection; and establishing the network connection with the first PLMN or the first cell.

Example 2 includes the method of example 1, wherein the IE includes a list of one or more pairs of a mobile country code (MCC) and a mobile network code (MNC) that correspond to the one or more PLMN IDs designated for the satellite cells.

Example 3 includes the method of example 1, wherein the IE includes a list of one or more tracking area IDs (TAIs) to indicate the one or more tracking areas.

Example 4 includes the method of example 3, wherein the one or more TAIs includes a plurality of TAIs, and wherein the IE includes a field to indicate that the list is a first type in which the TAIs are individually indicated in the list and belong to a same PLMN, a second type in which the TAIs are consecutive and belong to the same PLMN, or a third type in which the plurality of TAIs includes at least two TAIs that belong to different PLMNs.

Example 5 includes the method of example 1, wherein the IE includes a list of one or more absolute radio frequency channel numbers (ARFCNs) to indicate the one or more carrier frequencies.

Example 6 includes the method of example 5, wherein the one or more ARFCNs includes a plurality of ARFCNs, and wherein the IE includes a field to indicate that the list is a first type in which the ARFCNs are individually indicated in the list and belong to a same PLMN, a second type in which the ARFCNs are consecutive and belong to the same PLMN, or a third type in which the plurality of ARFCNs includes at least two ARFCNs that belong to different PLMNs.

Example 7 includes the method of example 1, wherein selecting the first PLMN or the first cell includes prioritizing a terrestrial PLMN or cell over PLMNs or cells that are indicated by the IE as designated for satellite cells.

Example 8 includes the method of example 1, wherein the IE further indicates one or more services supported in the one or more PLMN IDs, tracking areas, or carrier frequencies, and wherein selecting the first PLMN or the first cell includes prioritizing PLMNs or cells that support one or more required services of a user equipment (UE).

Example 9 includes the method of example 8, wherein the one or more services include one or more of a voice service, a video service, or a short message service (SMS).

Example 10 includes the method of example 1, wherein the mobility management message is received from a mobility management entity (MME) or an access and mobility management function (AMF), and wherein the mobility management message includes an attach accept message, a tracking area update accept message, a globally unique temporary identifier (GUTI) reallocation command, a detach request message, a detach accept message, a registration accept message, a configuration update command, a deregistration request message, or a deregistration accept message.

Example 11 includes the method of example 1, further comprising: identifying, based on the IE, that the first PLMN is a satellite PLMN or the first cell is a satellite cell; and applying one or more satellite-specific protocol adaptations in the NAS signaling towards the first PLMN or the first cell based on said identifying.

Example 12 includes the method of example 11, wherein the one or more satellite-specific protocol adaptations include one or more of: an adaptation of NAS timer values, support of a satellite-specific mobility management reject cause, or support of multiple tracking area codes (TACs) per cell.

Example 13 includes a method comprising: identifying one or more public land mobile network (PLMN) identities (IDs), tracking areas, or carrier frequencies that are designated for satellite cells in a network; and generating, for transmission to a user equipment (UE) via non-access stratum (NAS) signaling, a mobility management message including an information element (IE) to indicate the one or more PLMN IDs, tracking areas, or carrier frequencies.

Example 14 includes the method of example 13, wherein the IE includes a list of one or more pairs of a mobile country code (MCC) and a mobile network code (MNC) that correspond to the one or more PLMN IDs designated for the satellite cells.

Example 15 includes the method of example 13, wherein the IE includes a list of one or more tracking area IDs to indicate the one or more tracking areas.

Example 16 includes the method of example 13, wherein the IE includes a list of one or more absolute radio frequency channel numbers (ARFCNs) to indicate the one or more carrier frequencies.

Example 17 includes the method of example 13, wherein the IE further indicates one or more services supported in the one or more PLMN IDs, tracking areas, or carrier frequencies, wherein the one or more services include one or more of a voice service, a video service, or a short message service (SMS).

Example 18 includes the method of example 13, wherein the mobility management message includes an attach accept message, a tracking area update accept message, a globally unique temporary identifier (GUTI) reallocation command, a detach request message, a detach accept message, a registration accept message, a configuration update command, a deregistration request message, or a deregistration accept message.

Example 19 includes an apparatus comprising processing circuitry to: identify available public land mobile networks (PLMNs); select a first PLMN from the available PLMNs based on priority rules that prioritize PLMN and terrestrial access technology combinations over PLMN and satellite access technology combinations; and establish a connection with the first PLMN. The apparatus of example 19 may further comprise interface circuitry coupled to the processing circuitry to enable communication.

Example 20 includes the apparatus of example 19, wherein the priority rules are based further on service restrictions of the PLMN and satellite access technology combinations.

Example 21 includes the apparatus of example 19, wherein the processing circuitry is further to access an operator-controlled list of PLMNs for satellite access technology that indicates one or more of the PLMN and satellite access technology combinations in priority order, wherein the priority rules prioritize the one or more PLMN and satellite access technology combinations included in the operator-controlled list of PLMNs for satellite access technology over other PLMN and satellite access technology combinations.

Example 22 includes the apparatus of example 19, wherein the processing circuitry is to identify the PLMN and satellite access technology combinations based on an information element in a non-access stratum (NAS) message, wherein the information element indicates one or more PLMN IDs, tracking areas, or carrier frequencies that are reserved for satellite access technology.

Example 23 includes the apparatus of example 22, wherein the processing circuitry is to identify the PLMN and satellite access technology combinations based on an information element in the NAS message based on a configuration by a home PLMN (HPLMN) operator to use the information element.

Another example may include an apparatus comprising means to perform one or more elements of a method described in or related to any of examples 1-23, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-23, or any other method or process described herein.

Another example may include an apparatus comprising logic, modules, or circuitry to perform one or more elements of a method described in or related to any of examples 1-23, or any other method or process described herein.

Another example may include a method, technique, or process as described in or related to any of examples 1-23, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-23, or portions thereof.

Another example may include a signal as described in or related to any of examples 1-23, or portions or parts thereof.

Another example may include a datagram, information element, packet, frame, segment, PDU, or message as described in or related to any of examples 1-23, or portions or parts thereof, or otherwise described in the present disclosure.

Another example may include a signal encoded with data as described in or related to any of examples 1-23, or portions or parts thereof, or otherwise described in the present disclosure.

Another example may include a signal encoded with a datagram, IE, packet, frame, segment, PDU, or message as described in or related to any of examples 1-23, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-23, or portions thereof.

Another example may include a computer program comprising instructions, wherein execution of the program by a processing element is to cause the processing element to carry out the method, techniques, or process as described in or related to any of examples 1-23, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
receiving a mobility management message via non-access stratum (NAS) signaling, the mobility management message including an information element (IE) to indicate one or more public land mobile network (PLMN) identities (IDs), tracking areas, or carrier frequencies that are designated for satellite cells;
selecting, based on the IE, a first PLMN or a first cell with which to establish a network connection; and
establishing the network connection with the first PLMN or the first cell.

2. The method of claim 1, wherein the IE includes a list of one or more pairs of a mobile country code (MCC) and a mobile network code (MNC) that correspond to the one or more PLMN IDs designated for the satellite cells.

3. The method of claim 1, wherein the IE includes a list of one or more tracking area IDs (TAIs) to indicate the one or more tracking areas.

4. The method of claim 3, wherein the one or more TAIs includes a plurality of TAIs, and wherein the IE includes a field to indicate that the list is a first type in which the TAIs are individually indicated in the list and belong to a same PLMN, a second type in which the TAIs are consecutive and belong to the same PLMN, or a third type in which the plurality of TAIs includes at least two TAIs that belong to different PLMNs.

5. The method of claim 1, wherein the IE includes a list of one or more absolute radio frequency channel numbers (ARFCNs) to indicate the one or more carrier frequencies.

6. The method of claim 1, wherein selecting the first PLMN or the first cell includes prioritizing a terrestrial PLMN or cell over PLMNs or cells that are indicated by the IE as designated for satellite cells.

7. The method of claim 1, wherein the IE further indicates one or more services supported in the one or more PLMN IDs, tracking areas, or carrier frequencies, and wherein selecting the first PLMN or the first cell includes prioritizing PLMNs or cells that support one or more required services of a user equipment (UE).

8. The method of claim 1, wherein the mobility management message is received from a mobility management entity (MME) or an access and mobility management function (AMF), and wherein the mobility management message includes an attach accept message, a tracking area update accept message, a globally unique temporary identifier (GUTI) reallocation command, a detach request message, a detach accept message, a registration accept message, a configuration update command, a deregistration request message, or a deregistration accept message.

9. The method of claim 1, further comprising:
identifying, based on the IE, that the first PLMN is a satellite PLMN or the first cell is a satellite cell; and
applying one or more satellite-specific protocol adaptations in the NAS signaling towards the first PLMN or the first cell based on said identifying, wherein the one or more satellite-specific protocol adaptations include one or more of: an adaptation of NAS timer values, support of a satellite-specific mobility management reject cause, or support of multiple tracking area codes (TACs) per cell.

10. A method comprising:
identifying one or more public land mobile network (PLMN) identities (IDs), tracking areas, or carrier frequencies that are designated for satellite cells in a network; and
generating, for transmission to a user equipment (UE) via non-access stratum (NAS) signaling, a mobility management message including an information element (IE) to indicate the one or more PLMN IDs, tracking areas, or carrier frequencies.

11. The method of claim 10, wherein the IE includes a list of one or more pairs of a mobile country code (MCC) and a mobile network code (MNC) that correspond to the one or more PLMN IDs designated for the satellite cells.

12. The method of claim 10, wherein the IE includes a list of one or more tracking area IDs to indicate the one or more tracking areas.

13. The method of claim 10, wherein the IE includes a list of one or more absolute radio frequency channel numbers (ARFCNs) to indicate the one or more carrier frequencies.

14. The method of claim 10, wherein the IE further indicates one or more services supported in the one or more PLMN IDs, tracking areas, or carrier frequencies, wherein the one or more services include one or more of a voice service, a video service, or a short message service (SMS).

15. The method of claim 10, wherein the mobility management message includes an attach accept message, a tracking area update accept message, a globally unique temporary identifier (GUTI) reallocation command, a detach request message, a detach accept message, a registration accept message, a configuration update command, a deregistration request message, or a deregistration accept message.

16. An apparatus comprising:
processing circuitry to:
identify available public land mobile networks (PLMNs);
select a first PLMN from the available PLMNs based on priority rules that prioritize PLMN and terrestrial access technology combinations over PLMN and satellite access technology combinations; and
establish a connection with the first PLMN; and
interface circuitry coupled to the processing circuitry to enable communication.

17. The apparatus of claim 16, wherein the priority rules are based further on service restrictions of the PLMN and satellite access technology combinations.

18. The apparatus of claim 16, wherein the processing circuitry is further to access an operator-controlled list of PLMNs for satellite access technology that indicates one or more of the PLMN and satellite access technology combinations in priority order, wherein the priority rules prioritize the one or more PLMN and satellite access technology combinations included in the operator-controlled list of PLMNs for satellite access technology over other PLMN and satellite access technology combinations.

19. The apparatus of claim 16, wherein the processing circuitry is to identify the PLMN and satellite access technology combinations based on an information element in a non-access stratum (NAS) message, wherein the information element indicates one or more PLMN IDs, tracking areas, or carrier frequencies that are reserved for satellite access technology.

20. The apparatus of claim 19, wherein the processing circuitry is to identify the PLMN and satellite access technology combinations based on an information element in the NAS message based on a configuration by a home PLMN (HPLMN) operator to use the information element.
